(19) United States
(12) Patent Application Publication
(10) Pub. No.: US 2011/0168825 A1
(43) Pub. Date: Jul. 14, 2011

(54) SHREDDER

(76) Inventors: Mark Edward Fastabend, Chicago, IL (US); William James Fienup, St. Louis, MO (US); Sean Joel Corrigan, Chicago, IL (US)

(21) Appl. No.: 13/052,430

(22) Filed: Mar. 21, 2011

Related U.S. Application Data
(60) Provisional application No. 61/317,013, filed on Mar. 24, 2010.

(51) Int. Cl. B02C 18/00; B65H 5/06

(52) U.S. Cl. 241/285.1

(57) ABSTRACT

A shredder including a shredder mechanism and a feed mechanism, wherein the feed mechanism includes a first rotatable roller and a second rotatable roller to advance a material therebetween to the shredder mechanism for shredding, wherein at least one of the first roller and the second roller contacts an intermediate portion of the material to facilitate a feeding of the intermediate portion therebetween.

### CROSS-REFERENCE TO RELATED APPLICATION

This application claims the benefit of U.S. Provisional Patent Application Ser. No. 61/317,013 filed on Mar. 24, 2010 hereby incorporated herein by reference in its entirety.

### FIELD OF THE INVENTION

The invention relates to a shredder, and more particularly to a shredder capable of destroying stapled and unstapled documents.

### BACKGROUND OF THE INVENTION

A common type of shredder has a shredder mechanism contained within a housing that is mounted atop a container. The shredder mechanism typically includes a series of cutter elements. The cutter elements shred a material (e.g. sheets of paper) fed therein and discharge the shredded material downwardly into the container. Prior art shredders have a predetermined capacity or amount of material that can be shredded in one pass between the cutter elements. Typically, the material is fed into the shredder mechanism manually. Thus, when a user operates the shredder, the user can only manually insert, at a given time, the predetermined amount of material that can be shredded in one pass between the cutter elements. With manual-feed shredders, the user spends time feeding the predetermined amount of the material, thus taking away from a productivity of the user.

Other prior art shredders are designed for automatic feeding. The auto-feed shredders include a tray in which a stack of material can be placed. A feed mechanism advances the material into the shredding mechanism. This type of shredder is desirable in an office setting for productivity reasons, as the user can load the material into the tray and then leave the shredder to operate. However, when the material has been stapled and the staple(s) have not been removed, the feed mechanism can advance too many sheets of the material into the shredder mechanism. Thus, a jamming or an overloading of the cutter elements of the shredder mechanism may occur. To prevent such an occurrence, prior art shredders either require the user to remove the staple(s) from the material prior to inserting the material into the shredder or require the material to be inserted into the tray of the shredder in a predetermined orientation (e.g., stapled portion of the material positioned away from the cutter elements) such that the staple(s) can be removed by the shredder.

Accordingly, it would be desirable to produce a shredder including a shredder mechanism, which is capable of destroying stapled and unstapled material, wherein the material can be manually or automatically fed into the shredder mechanism in any orientation.

### SUMMARY OF THE INVENTION

In concordance and agreement with the present invention, a shredder including a shredder mechanism, which is capable of destroying stapled and unstapled material, wherein the material can be manually or automatically fed into the shredder mechanism in any orientation, has surprisingly been discovered.

In an embodiment, the shredder comprises: a housing including a feed bed formed therein, wherein the feed bed receives a material to be shredded therein; a shredder mechanism disposed in the housing, the shredder mechanism including at least one cutter element to convert the material to a shredded material; and a feed mechanism disposed in the housing, the feed mechanism including a first roller and a second roller located adjacent an intermediate portion of the feed bed, the first roller and the second roller cooperating to advance an intermediate portion of the material in a direction towards the shredder mechanism.

In another embodiment, the shredder comprises: a housing including a feed bed formed therein, wherein the feed bed receives a material to be shredded therein; a shredder mechanism disposed in the housing, the shredder mechanism including at least one cutter element to convert the material to a shredded material; a feed mechanism disposed in the housing, the feed mechanism including a first roller and a second roller, wherein one of the first roller and the second roller contacts an intermediate portion of the material to advance the intermediate portion of the material therebetween in a direction towards the shredder mechanism; and a panel coupled to the housing to provide access to the feed bed, the feed bed defined by an advancement mechanism coupled to the panel, wherein the advancement mechanism causes the material in the feed bed to be pressed against one of the first roller and the second roller.

In another embodiment, the shredder comprises: a housing including a feed bed formed therein, wherein the feed bed receives a material to be shredded therein; a shredder mechanism disposed in the housing, the shredder mechanism including at least one cutter element to convert a material to a shredded material; a feed mechanism disposed in the housing, the feed mechanism including a first roller, a second roller, and a third roller, wherein the first roller and the third roller contact an intermediate portion of the material to advance the intermediate portion of the material between the first roller and the second roller in a direction towards the shredder mechanism, and wherein a direction of rotation of the second roller is opposite a direction of rotation of the first roller and a direction of rotation of the third roller is the same as the direction of rotation of the second roller; and a panel coupled to the housing to provide access to the feed bed, the feed bed defined by an advancement mechanism coupled to the panel, wherein the advancement mechanism causes the material in the feed bed to be pressed against the first roller and the third roller.

### BRIEF DESCRIPTION OF THE DRAWINGS

The above, as well as other advantages of the present disclosure, will become readily apparent to those skilled in the art from the following detailed description, particularly when considered in the light of the drawings described herein.

FIG. 1 is a fragmentary side perspective view of a shredder according to an embodiment of the invention showing a panel of the shredder in an open position; and

FIG. 2 is a cross-sectional side elevational view of the shredder illustrated in FIG. 1 taken along line 2-2 of FIG. 1 and showing the panel of the shredder in a closed position and with a material to be shredded disposed therein.

### DETAILED DESCRIPTION OF EXEMPLARY EMBODIMENTS OF THE INVENTION

The following detailed description and appended drawings describe and illustrate various embodiments of the invention. The description and drawings serve to enable one skilled in the art to make and use the invention, and are not intended to limit the scope of the invention in any manner.

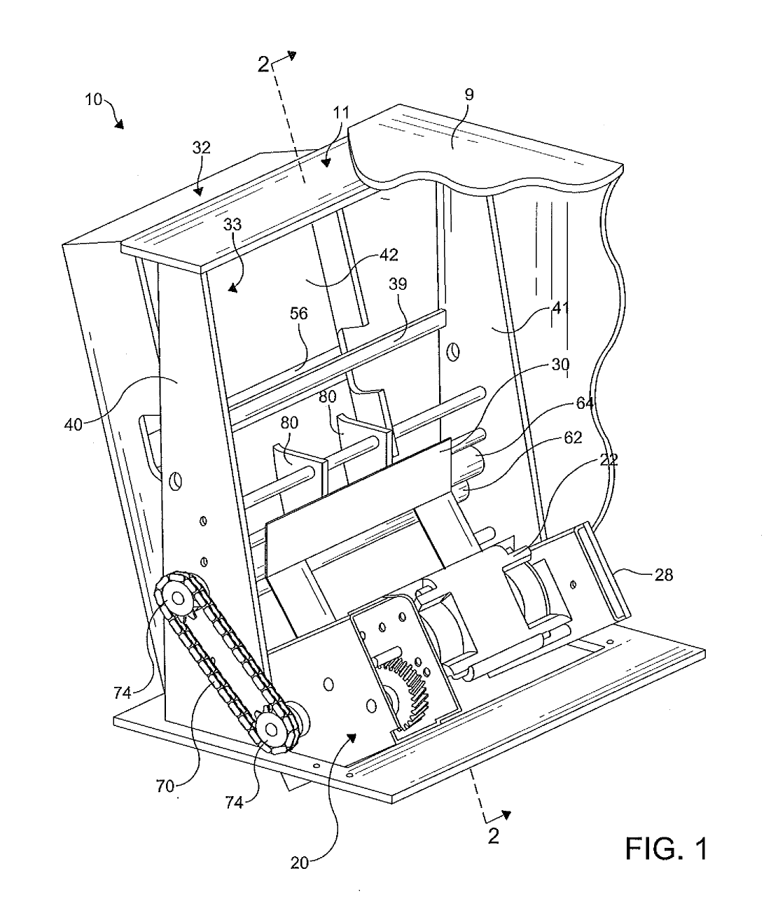

FIG. 1 shows a shredder 10 according to an embodiment of the present invention. The shredder 10 operates to destroy or shred material 12 such as a sheet or stack of stapled paper, a sheet or stack of wrinkled paper, envelopes, credit cards, compact discs, and the like, for example. It is understood that the shredder 10 may have any suitable size and shape as desired. The shredder 10 includes a housing 9 formed around a frame 11 and disposed on top of a container (not shown). The container receives the material 12 shredded by the shredder 10. The container may be a waste bin or an enclosure for receiving a removable waste bin, for example.

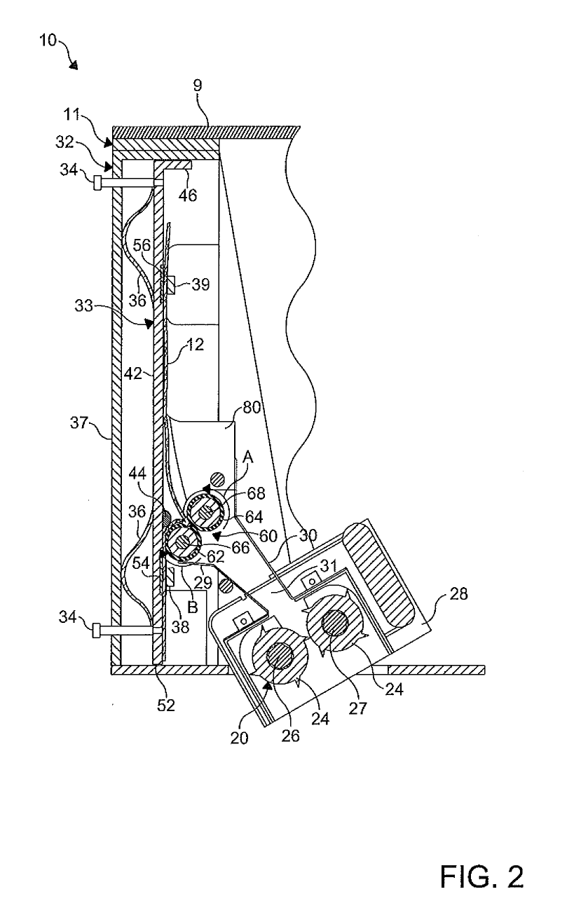

The housing 9 of the shredder 10 includes a shredder mechanism 20 disposed therein. The shredder mechanism 20 includes at least one motor 22 and a plurality of cutter elements 24. It is understood that the motor 22 can be any motor as desired such as an electrically powered motor, for example. As illustrated in FIG. 2, the cutter elements 24 are disposed on a pair of parallel shafts 26, 27. In the embodiment shown, the motor 22 operates to rotatably drive the shafts 26, 27 in opposite directions, including the cutter elements 24, and shred the material 12 fed into the shredder mechanism 20. The cutter elements 24 are disposed on the shafts 26, 27 in any suitable manner and are rotated in an interleaving relationship for shredding the material 12. The shredder mechanism 20 may also include a sub-frame 28 for mounting the shafts 26, 27 and the motor 22 to the housing 9.

A pair of guides 29, 30 forms a throat 31 of the shredder mechanism 20 to receive and guide the material 12 into the cutter elements 24. The shredder mechanism 20 may further include a second throat (not shown) which cooperates with an opening (not shown) formed in the housing 9 to permit a user to manually insert the material 12 into the shredder mechanism 20. In a non-limiting example, at least one of the guides 29, 30 cooperates with another guide (not shown) to form the second throat of the shredder mechanism 20. In another non-limiting example, a second pair of guides (not shown) forms the second throat of the shredder mechanism 20. It is understood that the guides 29, 30 can be formed from any suitable material as desired such as a metal material, a plastic material, and the like, for example. It is further understood that the guides 29, 30 can be formed integrally with the housing 9 if desired.

In the embodiment shown, the housing 9 further includes a panel 32 to provide access to a feed bed 33. The panel 32 is coupled to the housing 9 to facilitate a feeding of the material 12 from the feed bed 33 into the cutter elements 24 of the shredder mechanism 20. In a non-limiting example, the panel 32 is pivotally coupled to the housing 9, wherein the panel 32 is selectively positionable between an open position, as shown in FIG. 1, and a closed position, as shown in FIG. 2. In the open position of the panel 32, the panel 32 is tilted away from the housing 9 and the feed bed 33 is accessible to a user of the shredder 10, allowing the user to load the material 12 into the feed bed 33. In the closed position of the panel 32, the panel 32 is substantially flush with the housing 9 and the feed bed 33 is inaccessible to the user of the shredder 10, allowing the shredder mechanism 20 to be operated. A handle (not shown) may be provided on the panel 32 if desired.

In the embodiment shown, the feed bed 33 is defined by an advancement mechanism 42. The advancement mechanism 42 is selectively positionable within the panel 32 to hold and position the material 12 for shredding. Although the advancement mechanism 42 shown is coupled to the panel 32 by a pair of fasteners 34, it is understood that the advancement mechanism 42 can be coupled to the panel 32 by any means as desired. A plurality of urging members 36 is disposed between a wall of the panel 32 and the advancement mechanism 42. The urging members 36 cause the advancement mechanism 42 to travel within the panel 32 in a direction away from the wall 37 of the panel 32. Accordingly, the advancement mechanism 42 causes the material 12 to advance and be pressed against a pair of cross-members 38, 39. The cross-members 38, 39 shown extend between side supports 40, 41 of the frame 11. Additional or fewer urging members 36 than shown can be employed as desired. It is understood that the urging members 36 can be any suitable urging members as desired such as a leaf spring, a compression spring, a baffle, and the like, for example. It is further understood that each of the urging members 36 can exert a different force on the advancement mechanism 42 if desired. The advancement mechanism 42 is caused to travel within the panel 32 in an opposite direction towards the wall 37 of the panel 32 as the material 12 is loaded into the feed bed 33.

As illustrated in FIG. 2, the advancement mechanism 42 is a substantially planar plate having a buckling member 44 disposed thereon to cause the material 12 to bend. The buckling member 44 may be integrally formed with the advancement mechanism 42 if desired. The buckling member 44 shown is an elongate bar extending between opposite side edges of the advancement mechanism 42 and offset from a lower peripheral edge 52. Although the buckling member 44 has a substantially hemispheric cross-sectional shape, it is understood that the buckling member 44 can have any suitable shape and size as desired. The advancement mechanism 42 shown includes an arm member 46 laterally extending from an upper portion thereof. The arm member 46 acts as a stop for the material 12 during an operation of the shredder 10.

The advancement mechanism 42 may further include a low-friction zone 54 and a high-friction zone 56. The low-friction zone 54 is located between the buckling member 44 and the lower peripheral edge 52. The low-friction zone 54 can be produced from any suitable material or surface treatment as desired to minimize a coefficient of friction and facilitate a sliding of the material 12 such as a polytetrafluoroethylene (PTFE) material, a chemical process (e.g. employing a corrosive acid for chemically polishing), a mechanical process (e.g. coating or mechanically polishing), and the like, for example. In the embodiment shown, the low-friction zone 54 is produced by a piece of styrene material disposed in and extending between the opposite side edges of the advancement mechanism 42. The high-friction zone 56 is located between the buckling member 44 and the arm member 46. The high-friction zone 56 can be produced from any suitable material or surface treatment as desired to maximize the coefficient of friction and militate against a sliding of the material 12 such as a elastomer material, a chemical process (e.g. employing corrosive acid for chemically texturing), a mechanical process (e.g. rippling, grooving, or mechanically texturing), and the like, for example. In the embodiment shown, the high-friction zone 56 is produced by a piece of cork material disposed in and extending between the opposite side edges of the advancement mechanism 42.

The shredder 10 further includes a feed mechanism 60 for causing the material 12 from the feed bed 33 to be fed into the cutter elements 24 for shredding. As shown in FIG. 2, the feed mechanism 60 includes a rotatable first roller 62 and a rotatable second roller 64 located adjacent an intermediate portion of the feed bed 33. The rollers 62, 64 are mounted to respective axles 66, 68. The first roller 62 is positioned between the buckling member 44 and the cross-member 38 for engaging the material 12 and feeding the material 12 into the throat 31 of the shredder mechanism 20. The second roller 64 is disposed above and adjacent the first roller 62 for engaging the first roller 62 and feeding the material 12 into the throat 31 of the shredder mechanism 20. In the embodiment shown, the axle 68 of the second roller 64 is coupled to the motor 22 for effecting a rotational movement thereof and the first roller 62 is free. Accordingly, the second roller 64 rotates in a first direction, thereby causing the first roller 62 to rotate in an opposite second direction. As illustrated in FIG. 2, the second roller 64 rotates in a counter-clockwise direction as indicated by arrow A, thereby causing the first roller 62 to rotate in a clockwise direction as indicated by arrow B. It is understood, however, that the first roller 62 can be coupled to the motor 22 for effecting a rotational movement thereof and the second roller 64 is free, if desired. It is further understood that both the first roller 62 and the second roller 64 can be coupled to the motor 22 for effecting the rotational movement thereof, if desired. The rollers 62, 64 may be coupled to the motor 22 or a separate motor (not shown) for effecting the rotational movement thereof by any means as desired such as a chain 70 and gears 74 as shown in FIG. 1, for example.

In another embodiment, the feed mechanism 60 further includes a rotatable third roller (not shown). The third roller is positioned above the second roller 64 and below the cross-member 39. The third roller engages the material 12 and further bends the material 12 for feeding the material 12 between the rollers 62, 64. In a non-limiting example, the third roller rotates in the same direction as the second roller 64. The third roller can be coupled to the motor 22 or a separate motor (not shown) for effecting a rotational movement thereof.

In another embodiment, the buckling member 44 is offset from an upper peripheral edge of the advancement mechanism 42 and the arm member 46 laterally extends from a lower portion thereof. The low-friction zone 54 is located between the buckling member 44 and the upper peripheral edge of the advancement mechanism 42 and the high-friction zone 56 is located between the buckling member 44 and the arm member 46. Additionally, the first roller 62 is disposed between the cross-member 39 and the buckling member 44 and the second roller 64 is disposed below and adjacent the first roller 62 for engaging the first roller 62. Thus, the second roller 64 rotates in a clockwise direction and the first roller 62 rotates in a counter-clockwise direction. The shredder 10 of the embodiment may further include the third roller. The third roller is positioned below the second roller 64 and above the cross-member 38, wherein the third roller abuts the material 12. The third roller rotates in the same direction as the second roller 64. Thus, the third roller rotates in a clockwise direction.

As illustrated in FIGS. 1 and 2, the feed mechanism 60 may further include at least one buckling guide 80. The buckling guide 80 further facilitates a bending of the material 12 and directs the material 12 between the rollers 62, 64. It is understood that the buckling guide 80 can have any size and shape and can be formed from any suitable material as desired such as a metal material, a plastic material, and the like, for example. It is further understood that the buckling guide 80 can be integrally formed with the housing 9 if desired.

Additional components necessary for operation of the shredder 10 such as a control unit, a power source, electrical wiring, a locking mechanism for the panel 32, and the like, for example, may be disposed in the shredder 10 as desired. It is also understood that the shredder 10 may include various sensors and switches for controlling the operation of the shredder 10 such as a power switch, a sensor provided in the housing 9 for detecting an open or closed position of the panel 32, a sensor provided in the feed bed 33 for detecting a presence of the material 12 therein, and the like, for example.

In operation, the panel 32 is pivoted to the open position allowing the user to load the material 12 into the feed bed 33. After loading the material 12 into the feed bed 33, the panel 32 is pivoted to the closed position. In the closed position of the panel 32, each of the urging members 36 exert a force on the advancement mechanism 42 of the feed bed 33 to press the material 12 against the cross-members 38, 39 and the first roller 62. The shredder mechanism 20 and the feed mechanism 60 are then activated (e.g. upon closure of the panel 32, via a sensor, or manually).

When the shredder 10 is activated, the motor 22 causes the second roller 64 of the feed mechanism 60 to rotate in the counter-clockwise direction. The second roller 64 engages the first roller 62 and causes the first roller 62 to rotate in the clockwise direction. Rotational movement of the first roller 62 causes a portion intermediate a top edge and a bottom edge of a first sheet of the material 12 to slide upward over the low-friction zone 54 and contact the buckling member 44. The buckling member 44 causes the intermediate portion of the first sheet of the material 12 to bend towards and be fed between the rollers 62, 64. The intermediate portion of the first sheet of the material 12 may be further directed towards the rollers 62, 64 by the at least one buckling guide 80. In the embodiment shown, the high-friction zone 56 and the arm member 46 of the advancement mechanism 42 militate against upward movement of the first sheet of the material 12 in the feed bed 33 to further facilitate a bending of the intermediate portion of the first sheet of the material 12.

The motor 22 may also cause the third roller to rotate in the counter-clockwise direction. Rotational movement of the third roller causes the intermediate portion of the first sheet of the material 12 to slide downward. Accordingly, the intermediate portion of the first sheet of the material 12 is caused to further bend towards and be fed between the rollers 62, 64.

The intermediate portion of the first sheet of the material 12 is then grasped between the rollers 62, 64, causing the first sheet in its entirety to be fed therebetween. Accordingly, the intermediate portion of the material 12 is fed between the rollers 62, 64 prior to the edges of the material 12 being fed therebetween. The first sheet then advances through the throat 31 of the shredder mechanism 20 formed by the guides 29, 30 and into the cutter elements 24. The cutter elements 24 convert the first sheet of the material 12 into shredded material, which falls by gravity into the container. The feed mechanism 60 continues to feed each sheet of the material 12 into the cutter elements 24 until a desired number or all of the sheets of the material 12 have been converted into shredded material.

Referring to another embodiment of the invention, the motor 22 causes the second roller 64 of the feed mechanism 60 to rotate in the clockwise direction. The second roller 64 engages the first roller 62 and causes the first roller 62 to rotate in the counter-clockwise direction. Rotational movement of the first roller 62 causes the intermediate portion of the first sheet of the material 12 to slide downward over the low-friction zone 54 and contact the buckling member 44. The high-friction zone 56 and the arm member 46 of the advancement mechanism 42 militate against downward movement of the first sheet of the material 12 in the feed bed 33 to further facilitate a bending of the intermediate portion of the first sheet of the material 12. The motor 22 may also cause the third roller to rotate in the clockwise direction. Rotational movement of the third roller causes the intermediate portion of the first sheet of the material 12 to slide upward.

When the material 12 is stapled along and/or adjacent a bottom edge thereof, the cross-member 38 extends into a path of which the stapled material 12 is drawn because the stapled material 12 is pressed against the cross-member 38 by the urging members 36. Thus, as a sheet of the stapled material 12 is grasped by the rollers 62, 64 and fed into the shredder mechanism 20, the cross-member 38 intercedes by providing resistance to the stapled material 12. Accordingly, the resistance provided by the cross-member 38 allows the sheet to be stripped or sheared from the staple(s) disposed along and/or adjacent the bottom edge of the material 12. In the embodiment shown, the cross-member 38 provides resistance by contacting a portion of the sheet above the staple(s) or contacting the staple(s) to hold the stapled material 12.

When the material 12 is stapled along and/or adjacent a top edge thereof, the cross-member 39 extends into a path of which the stapled material 12 is drawn because the stapled material 12 is pressed against the cross-member 39 by the urging members 36. Thus, as a sheet of the stapled material 12 is grasped by the rollers 62, 64 and fed into the shredder mechanism 20, the cross-member 39 intercedes by providing resistance to the stapled material 12. Accordingly, the resistance provided by the cross-member 39 allows the sheet to be stripped or sheared from the staple(s) disposed along and/or adjacent the top edge of the material 12. In the embodiment shown, the cross-member 39 provides resistance to the stapled material 12 by contacting a portion of the sheet below the staple(s) or contacting the staple(s) to hold the stapled material 12.

Alternatively, the user can manually insert the material 12 through the opening formed in the housing 9 and into the second throat of the shredder mechanism 20. Accordingly, the material 12 for shredding bypasses the panel 32 and the feed mechanism 60. This feature may be advantageous, for example, where the user simply wants to shred a limited amount of material 12, compact discs, credits cards, thick envelopes, and the like, for example.

The invention is not limited to the embodiments described and represented in the attached drawings. Modifications are still possible, in particular with regard to the configuration of the various elements or substituting equivalent techniques without departing as such from the scope of protection of the invention.

What is claimed is:

1. A shredder comprising:
a housing including a feed bed formed therein, wherein the feed bed receives a material to be shredded therein;
a shredder mechanism disposed in the housing, the shredder mechanism including at least one cutter element to convert the material to a shredded material; and
a feed mechanism disposed in the housing, the feed mechanism including a first roller and a second roller located adjacent an intermediate portion of the feed bed, the first roller and the second roller cooperating to advance an intermediate portion of the material in a direction towards the shredder mechanism.

2. The shredder according to claim 1, wherein one of the first roller and the second roller contacts the intermediate portion of the material to facilitate a feeding of the intermediate portion between the first roller and the second roller.

3. The shredder according to claim 1, wherein a direction of rotation of the first roller is opposite a direction of rotation of the second roller.

4. The shredder according to claim 1, further comprising a panel pivotally coupled to the housing to provide access to the feed bed.

5. The shredder according to claim 4, further comprising an advancement mechanism coupled to the panel, where the advancement mechanism causes the material to be pressed against at least one of the first roller and the second roller.

6. The shredder according to claim 5, wherein the advancement mechanism is a substantially planar plate.

7. The shredder according to claim 5, further comprising at least one urging member disposed between the panel and the advancement mechanism, wherein the at least one urging member exerts a force on the advancement mechanism.

8. The shredder according to claim 5, wherein the advancement mechanism includes a buckling member disposed thereon to facilitate a feeding of the material into the feed mechanism.

9. The shredder according to claim 5, wherein the advancement mechanism includes a low-friction zone abutting at least a portion of the material.

10. The shredder according to claim 5, wherein the advancement mechanism includes a high-friction zone abutting at least a portion of the material.

11. The shredder according to claim 1, further comprising at least one cross-member extending between side supports of a frame of the housing.

12. The shredder according to claim 1, further comprising at least one buckling guide disposed in the housing to direct the material between the first roller and the second roller.

13. The shredder according to claim 1, further comprising a third roller disposed in the housing to abut at least a portion of the material.

14. The shredder according to claim 13, wherein a direction of rotation of the third roller is the same as a direction of rotation of the second roller.

15. A shredder comprising:
a housing including a feed bed formed therein, wherein the feed bed receives a material to be shredded therein;
a shredder mechanism disposed in the housing, the shredder mechanism including at least one cutter element to convert the material to a shredded material;
a feed mechanism disposed in the housing, the feed mechanism including a first roller and a second roller, wherein one of the first roller and the second roller contacts an intermediate portion of the material to advance the intermediate portion of the material therebetween in a direction towards the shredder mechanism; and
a panel coupled to the housing to provide access to the feed bed, the feed bed defined by an advancement mechanism coupled to the panel, wherein the advancement mechanism causes the material in the feed bed to be pressed against one of the first roller and the second roller.

16. The shredder according to claim 15, wherein the advancement mechanism includes a buckling member disposed thereon to facilitate a feeding of the material into the feed mechanism.

17. The shredder according to claim 15, wherein the advancement mechanism includes a low-friction zone abutting at least a portion of the material.

18. A shredder according to claim 15, wherein the advancement mechanism includes a high-friction zone abutting at least a portion of the material.

19. A shredder comprising:
a housing including a feed bed formed therein, wherein the feed bed receives a material to be shredded therein;
a shredder mechanism disposed in a housing, the shredder mechanism including at least one cutter element to convert the material to a shredded material;
a feed mechanism disposed in the housing, the feed mechanism including a first roller, a second roller, and a third roller, wherein the first roller and the third roller contact an intermediate portion of the material to advance the intermediate portion of the material between the first roller and the second roller in a direction towards the shredder mechanism, and wherein a direction of rotation of the second roller is opposite a direction of rotation of the first roller and a direction of rotation of the third roller is the same as the direction of rotation of the second roller; and
a panel coupled to the housing to provide access to the feed bed, the feed bed defined by an advancement mechanism coupled to the panel, wherein the advancement mechanism causes the material in the feed bed to be pressed against the first roller and the third roller.

20. The shredder according to claim 19, wherein the first roller and the second roller are located adjacent an intermediate portion of the feed bed.
